(19) United States
(12) Patent Application Publication
(10) Pub. No.: US 2007/0233481 A1
(43) Pub. Date: Oct. 4, 2007

(54) SYSTEM AND METHOD FOR DEVELOPING HIGH ACCURACY ACOUSTIC MODELS BASED ON AN IMPLICIT PHONE-SET DETERMINATION-BASED STATE-TYING TECHNIQUE

(75) Inventor: Kaisheng N. Yao, Dallas, TX (US)

Correspondence Address: TEXAS INSTRUMENTS INCORPORATED, P O BOX 655474, M/S 3999, DALLAS, TX, 75265, US

(73) Assignee: Texas Instruments Inc., Dallas, TX (US)

(21) Appl. No.: 11/278,504

(22) Filed: Apr. 3, 2006

(51) Int. Cl. G10L 15/06

(52) U.S. Cl. 704/245

(57) ABSTRACT

A system for, and method of, developing high accuracy acoustic models and a digital signal processor incorporating the same. In one embodiment, the system includes: (1) an acoustic model initializer configured to generate initial acoustic models by seeding with seed monophones, (2) a monophone retrainer associated with the acoustic model initializer and configured to retrain the monophones using a target database, (3) a triphone generator associated with the monophone retrainer and configured to generate seed triphones from the monophones using aligned training data, (4) a triphone retrainer associated with the triphone generator and configured to retrain the triphones using the target database and (5) a triphone clusterer associated with the triphone retrainer and configured to cluster the triphones using a state-tying technique, the triphone retrainer configured to retrain the triphones again using the target database.

### CROSS-REFERENCE TO RELATED APPLICATIONS

The present invention is related to U.S. Pat. No. [Ser. No. 11/196,601] by Yao, entitled “System and Method for Creating Generalized Tied-Mixture Hidden Markov Models for Automatic Speech Recognition,” filed Aug. 3, 2005, commonly assigned with the present invention and incorporated herein by reference.

### TECHNICAL FIELD OF THE INVENTION

The present invention is directed, in general, to automatic speech recognition (ASR) and, more specifically, to a system and method for developing high accuracy acoustic models based on an implicit phone-set determination-based state-tying technique.

### BACKGROUND OF THE INVENTION

With the widespread use of mobile devices and a need for easy-to-use human-machine interfaces, ASR has become a major research and development area. Speech is a natural way to communicate with and through mobile devices. It is most appropriate that speech-driven applications should be able to recognize speech conducted in the user's native tongue.

Unfortunately, significant complications stand in the way of bringing native-tongue-capable speech-driven applications into wide use. First, thousands of different languages and dialects are spoken in the world today. Hundreds of those are widely spoken. Applications need to adapt to at least the widely-spoken languages to come into wide use. Second, speech applications need to be introduced quickly and cost-efficiently. Unfortunately, the multiplicity of human languages frustrates this need. A solution is needed to this problem.

ASR is performed by comparing a set of acoustic models with input speech features. Therefore, the acoustic models form a key component of an ASR system. Acoustic models are based on units of speech ranging from words to monophones or triphones. Monophones are solitary phones without any phone context. Triphones comprehend the prior and subsequent phone contexts of a given phone and therefore typically outperform monophones. Unfortunately, while triphones provide better performance, the number of parameters in triphones is often so large that constraints are necessary to avoid problems arising from data insufficiency. These constraints aim to reduce the set of parameters in triphones by grouping the triphones into a statistically estimable number of clusters using decision trees (see, e.g., Hwang, “Sub-Phonetic Acoustic Modeling for Speaker-Independent Continuous Speech Recognition,” Ph.D. Thesis, Carnegie Mellon University, 1993). The decision trees result in sharing of output probability density functions (PDFs) across states. This is known as “state tying.”

Triphones of a given phone are first pooled together. Then, questions are found that yield the best sequential split of these triphones until the increase of an optimization criterion because of the sequential split falls below a specified threshold. State tying is well known (see, e.g., Young, The HTKBOOK, Cambridge University, 2.1 edition, 1997) but has always required substantial human involvement, as the phoneme set and pronunciation dictionaries require careful definition. Unfortunately, human involvement is slow, tedious and error-prone. It is critical to have automatic methods that reliably cluster triphones without substantial human involvement to allow ASR systems to be rapidly deployed to new applications.

Previous approaches to automatic methods have dealt with some aspect of acoustic model training. With a small amount of in-domain data, one approach adapts parameters of existing acoustic models, usually mean and variance parameters, in a reference application by applying maximum-likelihood linear regression (MLLR)-type methods (see, e.g., Woodland, et al., “Improving Environmental Reliableness in Large Vocabulary Speech Recognition,” in ICASSP, 1996, pp. 65-68). Unfortunately, performance in the target domain may be limited because the decision trees for triphone clustering are not adapted as well. Another approach refined the above-mentioned approach by adapting not only the mean and variance parameters, but also the decision trees, with in-domain data (see, e.g., Singh, et al., “Domain Adduced State Tying for Cross-Domain Acoustic Modelling,” in EUROSPEECH, 1999). Yet another approach is directed to better initialization of acoustic models in the target domain (see, e.g., Netsch, et al., “Automatic and Language Independent Triphone Training Using Phonetic Tables,” in ICASSP, 2004). Seed monophones are constructed in the target domain by referring similar monophones in a reference domain. Similarity is measured in terms of similarity of articulatory properties.

Approaches to automatic question generation (see, e.g., Beulen, et al., “Automatic Question Generation for Decision Tree Based State Tying,” in ICASSP, 1998, pp. 805-808) also exist. However, all of the conventional approaches assume that the phoneme set for the target domain is reliably defined. Unfortunately, this assumption does not hold for new applications such as ASR in foreign languages.

Accordingly, what is needed in the art is a way to develop high accuracy acoustic models automatically. More specifically, what is needed in the art is an implicit phone-set determination-based state-tying technique that can form the basis for a system and method for developing high accuracy acoustic models. The system and method should advantageously reduce the time and cost currently required to incorporate ASR into new applications and for a variety of languages.

### SUMMARY OF THE INVENTION

To address the above-discussed deficiencies of the prior art, the present invention provides a way to develop high accuracy acoustic models automatically.

The foregoing has outlined features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a high-level schematic diagram of a wireless telecommunication infrastructure containing a plurality of mobile telecommunication devices within which the system and method and underlying state-tying technique of the present invention can operate;

FIG. 2 illustrates a flow diagram of one embodiment of a method of developing high accuracy acoustic models carried out according to the principles of the present invention;

FIGS. 3A and 3B together illustrate decision trees after application of a conventional state-tying technique;

FIGS. 4A and 4B together illustrate decision trees after application of a novel implicit phone-set determination-based state-tying technique carried out according to the principles of the present invention; and

FIG. 5 illustrates a block diagram of one embodiment of a system for developing high accuracy acoustic models carried out according to the principles of the present invention.

### DETAILED DESCRIPTION

Introduced herein are a novel automatic acoustic model training system and method. A key component of the novel system and method is a novel technique of state tying. In contrast to conventional state tying approaches that question the phonetic contexts of triphones (see, e.g., Young, supra; Singh, et al., supra; Netsch, et al., supra; and Beulen, et al., supra), the novel technique also identifies the center phones of the triphones. Hence, the novel technique relaxes the requirement for reliable phone-set definition. The novel technique is named as implicit phone-set determination based state tying. Certain embodiments of the novel technique have the following advantages.

First, triphones for growing a decision tree are not required to be from the same phone. Whereas conventional state tying approaches (see, e.g., Young, supra; Singh, et al., supra; Netsch, et al., supra; and Beulen, et al., supra) call for separate decision trees to be grown for different phones, the novel technique allows sharing a common decision tree for triphones from several selected phones. Hence, the novel technique allows more flexible tying of triphone parameters.

Second, with the flexibility of allowing triphones from different phones to share the same decision tree, the novel technique relaxes the requirement for an accurate phoneme set. The flexibility is achieved without loss of performance. Given an optimization criterion, such as the increase of likelihood in (see, e.g., Young, supra), center phone is questioned only when the question results in the best split of triphones in terms of the optimization criterion. Hence, instead of relying on the accuracy of the manually constructed phone-set, which is error-prone in new applications and new languages, the novel technique classifies these phonemes using the data-driven approach that optimizes a pre-specified criterion. Since the criterion, such as maximum likelihood, can be designed to optimize ASR performance, the technique may achieve better performance than conventional triphone state tying methods.

Third, the novel technique may achieve a small footprint (reduced memory requirement) while maintaining high performance. In the state tying technique, some other optimization criterions such as the minimum description length (MDL) principle (see, e.g., Shinoda, et al., “Acoustic Modeling Based on the MDL Principle for Speech Recognition,” in EUROSPEECH, 1997) may be used to control the number of triphone states. In addition, performance may be improved by using a data-driven Gaussian mixture-tying technique (see, e.g., Yao, supra) that is applied after several iterations of the well-known Expectation-Maximization (E-M) algorithm (see, e.g., Rabiner, “A Tutorial on Hidden Markov Models and Selected Applications in Speech Recognition,” Proceedings of the IEEE, vol. 77, no. 2, 1989) training of the state-tied triphones. The Gaussian mixture-tying technique shares Gaussian densities in other triphone states. Hence, the performance of the novel technique may be improved without increasing the total number of Gaussian densities.

The effectiveness of certain embodiments of the novel technique will be demonstrated in a series of experiments set forth below involving Japanese city name recognition. The Japanese ASR system was rapidly developed using the novel technique. Compared to a reference baseline system, the novel technique achieved better performance with a smaller footprint.

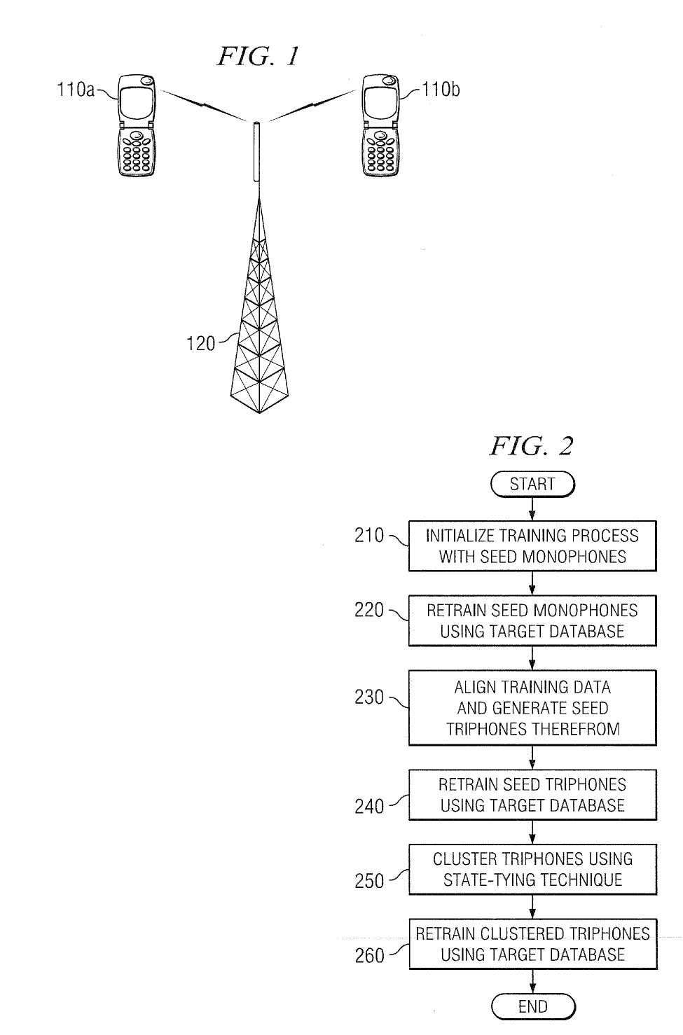

Before describing an embodiment of the technique, a wireless telecommunication infrastructure in which the novel automatic acoustic model training system and method and the underlying novel state-tying technique of the present invention may be applied will be described. Accordingly, referring to FIG. 1, illustrated is a high level schematic diagram of a wireless telecommunication infrastructure, represented by a cellular tower 120, containing a plurality of mobile telecommunication devices 110a, 110b within which the system and method of the present invention can operate.

One advantageous application for the system or method of the present invention is in conjunction with the mobile telecommunication devices 110a, 110b. Although not shown in FIG. 1, today's mobile telecommunication devices 110a, 110b contain limited computing resources, typically a DSP, some volatile and nonvolatile memory, a display for displaying data, a keypad for entering data, a microphone for speaking and a speaker for listening. Certain embodiments of the present invention described herein are particularly suitable for operation in the DSP. The DSP may be a commercially available DSP from Texas Instruments of Dallas, Tex.

Having described an exemplary environment within which the system or the method of the present invention may be employed, various specific embodiments of the system and method will now be set forth. FIG. 2 illustrates a flow diagram of one embodiment of a method of developing high accuracy acoustic models carried out according to the principles of the present invention.

The method of FIG. 2 has the following steps:

Monophone seeding (performed in a step 210). Monophone seeding initializes the training processes. Usually, monophone seeding is constructed manually. They are often imprecise, for example the flat start approach in HTK (see, e.g., Young, supra), or require a manual phonetic transcription of all or parts of the database. A monophone seeding method introduced in Netsch, et al., supra, may be used. In the illustrated embodiment of the novel technique, each phone in the target domain is matched to a reference phone in the reference domain. Similarity is measured in terms of articulatory characteristics. Relevant articulatory characteristics may include phone class (e.g., vowel, diphthong or consonant), phone length and other characteristics as may be advantageous for a particular application.

Monophone retraining (performed in a step 220). Seed monophones are retrained (re-estimated) using the entire target database. Those skilled in the pertinent art will understand, however, that the seed monophones may be retrained using only part of the target database.

Monophone cloned into triphone (performed in a step 230). The training data is aligned using the monophones. Triphone contexts are then generated and associated to create seed triphones.

Triphone training (performed in a step 240). Each triphone is re-trained (re-estimated) using the entire target database.

State tying (performed in a step 250). A novel state-tying technique, described below, is applied.

Clustered triphone retraining (performed in a step 260). The clustered triphones after the state-tying step 250 are retrained (re-estimated) using the entire target database.

Subsequent training operations, such as gender-dependent training and a novel Gaussian mixture-tying scheme, introduced in Yao, supra, may then be performed as described below.

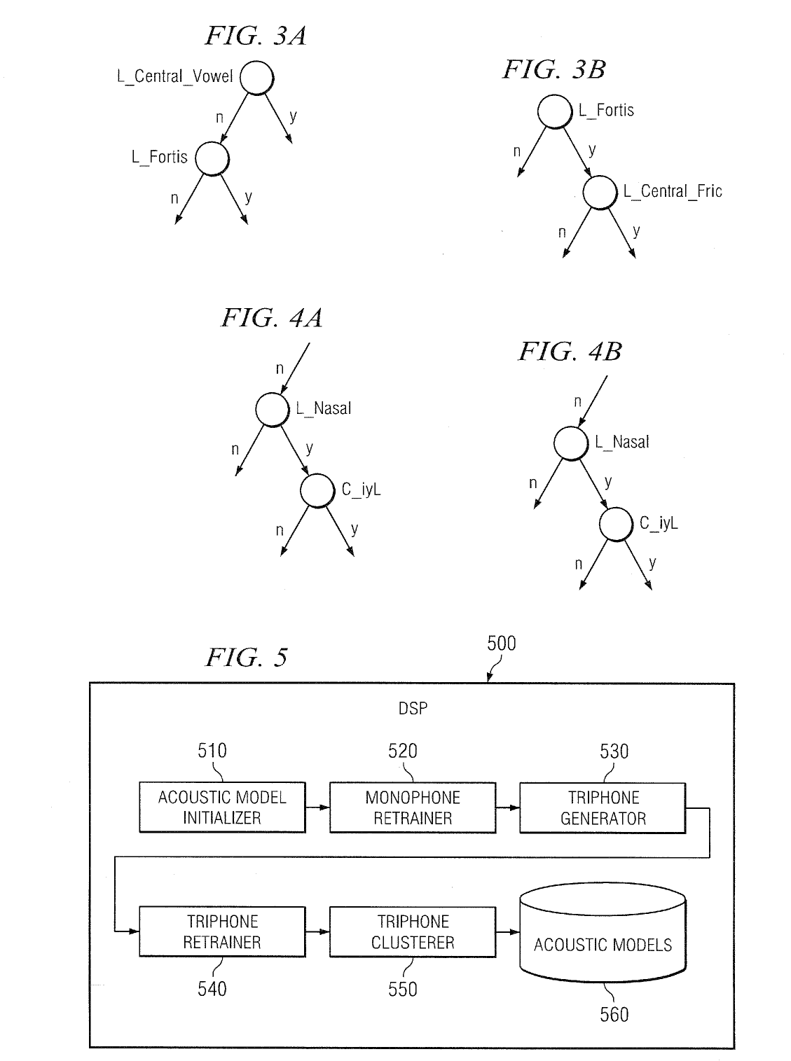

Decision-tree-based state tying allows parameter sharing at leaf nodes of a tree. Typically, one decision tree is grown for each state of each phone. For example, with 45 phonemes in a phone set, 135 separate decision trees are built for the three-state phonemes. Parameter sharing is not allowed across different phones. However, phonemes, such as the short vowel “iy” and the long vowel “iyL” may in fact share some common characteristics. FIGS. 3A and 3B together illustrate decision trees after application of a conventional state-tying technique. Notice that the question “L_Fortis” is in the second and first level of the decision trees, respectively, for “iy” and “iyL.”

The conventional state-tying technique of FIGS. 3A and 3B assumes that the two phonemes are well separable in terms of their phonetic contexts and their acoustic characteristics. However, those assumptions do not frequently hold in practical applications. The following is far more common:

In sloppy speech, people do not differentiate phonemes as much as they do in read speech. Different phonemes tend to exhibit more similarity.

It is difficult to have reliable and accurate determination of phoneme set for new applications and in new languages. Hence, a typical state-tying technique may either over-parameterize or under-parameterize the trained acoustic models.

In contrast, a novel implicit phone-set determination-based state-tying technique that will now be introduced. Initially, all selected polyphones (triphones) are pooled together at the root of a single decision tree. For example, the polyphones of “iy” and “iyL” may be selected for pooling together. The clustering procedure then grows the decision tree by selecting questions that maximize an optimization criterion, for example, maximum likelihood (see, e.g., Young, supra). The questions are asked regarding the identity of the center phone and its neighboring phones. The tree is grown until it reaches a minimum count threshold. Compared to the typical state-tying technique, a single tree allows more flexible sharing of parameters of the polyphones.

The state-tying technique may grow a decision tree for each polyphone. However, it may be more beneficial in certain applications instead to grow a decision tree for each class of polyphones. For example, two classes of polyphones (e.g., vowel and consonant) may be constructed first, resulting in each class having its decision tree. Polyphones within a class share the same decision tree. In contrast, conventional clustering techniques grow a decision tree for each polyphone, irrespective of possible common characteristics among the polyphones.

Examples include the “iy” and “iyL” phones of FIGS. 3A and 3B. Some lexicons choose to differentiate them. In these lexicons, they are most often not marked consistently because of pronunciation variation, for example. Accurate classification of the phonemes is difficult and error-prone. The proposed state tying relaxes the tough and error-prone requirement of accurate phone-set determination. In the proposed scheme, if triphones are indistinguishable under certain contexts, they will be allowed to share the same parameter. Otherwise, if they show sufficient differences under certain other contexts, they will use different parameters.

FIGS. 4A and 4B together illustrate decision trees after application of a novel implicit phone-set determination-based state-tying technique carried out according to the principles of the present invention. State 2 of polyphones of “iy” and “iyL” share the same decision tree. In a certain level of the decision tree, polyphones are split according to their answers to “C_iyL,” which is “Q: is the center phone iyL?.” For contexts above the level of the question or answering “n” to question “L_Nasal,” polyphones of “iy” and “iyL” share the same parameters.

Further performance may be improved by using the Gaussian mixture-tying technique introduced in Yao, supra. A statistic measure, the Bhattacharyya distance, may be used to provide distances among PDFs. The Bhattacharyya distance, the distance between two Gaussian components {nᵢ(·;μᵢ, Σᵢ); i=1,2}, is

$$D ( {N}_{1} , {N}_{2} ) = \frac{1}{8} {( {μ}_{1} - {μ}_{2} )}^{2} {( ( {Σ}_{1} + {Σ}_{2} ) / 2 )}^{- 1} + \frac{1}{2} ln \frac{( {Σ}_{1} + {Σ}_{2} ) / 2}{{‖ {Σ}_{1} ‖}^{1 / 2} {‖ {Σ}_{2} ‖}^{1 / 2}}$$

where μᵢ and Σᵢ are the mean and variance, respectively, for the Gaussian component Nᵢ. Sharing of PDFs can be done among Gaussian components with the shortest distances to the given PDF. The ability to discriminate phones is attained by: (1) using different mixture weights and (2) sharing different mixture components with other states.

Whereas Yao, supra, certainly encompasses mixture tying irrespective of the characteristics of the center phones, some constraints may be advantageously incorporated into the automatic training method during as the Gaussian mixture-tying technique is carried out. These constraints may include:

Only PDFs that have the same gender and the same center phone are allowed to be tied together.

Those PDFs that have center phones belonging to the same pool of triphones are allowed to be tied together. Other constraints fall within the broad scope of the present invention.

Notice that the second constraint is more relaxed than the first constraint. It has been found empirically that these constraints are useful to generate high accurate acoustic models, because: (1) number of Gaussian PDFs per state is increased so that each triphone state can have better representation of distribution of observation and (2) details of triphone clustering may be kept with these constraints. Without such constraints, the mixture tying procedure in Yao, supra, may mixture-tie two PDFs that reduce details of acoustic modeling. For example, two PDFs, one from a female model and the other from a male model, may appear to be close, but are actually occur in completely different contexts. Mixture-tying those two PDFs introduces ambiguity into the acoustic context and may therefore decrease system performance.

One embodiment of the implicit phone-set determination-based state-tying technique introduced herein is summarized as follows. In a first step, polyphones are grouped into several classes. In this step, phonetic knowledge may be used to classify polyphones as members of selected classes, such as vowel and consonant. In a second step, a question set is constructed for each class. The question set should include questions on center phones, and may include questions on the contexts of the center phones. In a third step, a decision tree is grown for each class. In this step, the question that yields the largest likelihood increase is preferably selected to grow the decision tree. Then, the question among the remaining questions that yields the largest increase of likelihood is selected to further grow the decision tree. Further questions are selected to grow the decision tree, perhaps until the increase of likelihood falls below a desired threshold. In a subsequent step, acoustic models are trained with the grown decision trees and may be refined using conventional or later-developed performance improvement methods, such as the Gaussian mixture-tying technique described above.

Having described various embodiments of the method and the underlying implicit phone-set determination-based state-tying technique introduced herein, one embodiment of a system for developing high accuracy acoustic models carried out according to the principles of the present invention will now be described. Accordingly, FIG. 5 illustrates such a system, embodied in a sequence of instructions executable in the data processing and storage circuitry of a DSP 500.

The system includes an acoustic model initializer 510. The acoustic model initializer 510 is configured to generate initial acoustic models by seeding with seed monophones. The acoustic model initializer 510 may be further configured to match each monophone in a target domain to a reference monophone in a reference domain using at least one articulatory characteristic.

The system further includes a monophone retrainer 520. The monophone retrainer 520 is associated with the acoustic model initializer 510 and is configured to retrain the monophones using a target database, advantageously an entirety thereof.

The system further includes a triphone generator 530. The triphone generator 530 is associated with the monophone retrainer 520 and is configured to generate seed triphones from the monophones using aligned training data. The triphone generator 530 may align the training data using the monophones before generating the seed triphones.

The system further includes a triphone retrainer 540. The triphone retrainer 540 is associated with the triphone generator 530 and is configured to retrain the triphones using the target database, advantageously an entirety thereof.

The system further includes a triphone clusterer 550. The triphone clusterer 550 is associated with the triphone retrainer 540 and configured to cluster the triphones using a state-tying technique. The state-tying technique may be an implicit phone-set determination-based state-tying technique as described above. The state-tying technique may tie states associated with the triphones based on Bhattacharyya distances and constraints as described above.

The triphone retrainer 540 is configured to retrain the triphones again using the target database, advantageously an entirety thereof. The result is a database containing acoustic models 560.

To assess performance of the new system, method and underlying technique, one embodiment of the method of developing high accuracy acoustic models introduced herein was used to train a Japanese city name recognition system.

Portions of the well-known Acoustical Society of Japan (ASJ) database and the well-known Japan Electronic Industry Development Association (JEIDA) city name database were used to train acoustic models of the system. Testing was carried out on the remaining portion of the JEIDA city name database. The testing set contained 100 city names uttered by 25 male and 25 female speakers. Each speaker generated around 400 utterances, resulting in 19,258 total utterances.

The method introduced herein allows flexible assignment of polyphones with different center phones. Therefore, experiments were conduced with four different systems, designated System I, System II, System III and System IV, having the following respective assignments of polyphone classes:

System I: The polyphones are classified into general classes such as closure and consonant. These classes are:

VOWEL

DIPHTHONG

CONSONANT

SEMIVOWEL

CLOSURE

SILENCE

System II: The polyphones are assigned with more detailed classes. For example, vowel is more specified as to whether it is an A or a U.

CLOSURE

CONSONANT && ALVEOLAR

CONSONANT && ALVPALATAL

CONSONANT && BILABIAL

CONSONANT && LABDENTAL

CONSONANT && LABIAL

CONSONANT && VELAR

DIPHTHONG

SEMIVOWEL

SILENCE

VOWEL && A

VOWEL && E

VOWEL && I

VOWEL && O

VOWEL && U

System III: Decision trees for silence and short pauses are separated in the system. Vowels are further detailed to whether they are long vowel or short vowel.

CLOSURE

CONSONANT && ALVEOLAR

CONSONANT && ALVPALATAL

CONSONANT && BILABIAL

CONSONANT && LABDENTAL

CONSONANT && LABIAL

CONSONANT && VELAR

DIPHTHONG

SEMIVOWEL

sil

Sp

VOWEL && A && LONG

VOWEL && A && SHORT

VOWEL && E && LONG

VOWEL && E && SHORT

VOWEL && I && LONG

VOWEL && I && SHORT

VOWEL && O && LONG

VOWEL && O && SHORT

VOWEL && U && LONG

VOWEL && U && SHORT

System IV: Consonants are detailed to whether they are voiced or unvoiced, together with their syllabic status, such as bilabial. Some vowels are more specific as to their position status, such as central.

CLOSURE

CONSONANT && ALVEOLAR && VOICED

CONSONANT && ALVEOLAR && UNVOICED

CONSONANT && ALVPALATAL && VOICED

CONSONANT && ALVPALATAL && UNVOICED

CONSONANT && BILABIAL && VOICED

CONSONANT && BILABIAL && UNVOICED

CONSONANT && LABDENTAL && VOICED

CONSONANT && LABDENTAL && UNVOICED

CONSONANT && LABIAL && VOICED

CONSONANT && LABIAL && UNVOICED

CONSONANT && VELAR && VOICED

CONSONANT && VELAR && UNVOICED

DIPHTHONG

SEMIVOWEL && ALVEOLAR

SEMIVOWEL && BILABIAL

SEMIVOWEL && ALVPALATAL

sil

sp

VOWEL && A && LONG && CENTRAL

VOWEL && A && LONG && FRONT

VOWEL && A && SHORT && CENTRAL

VOWEL && A && SHORT && FRONT

VOWEL && E && LONG && FRONT

VOWEL && E && LONG && CENTRAL

VOWEL && E && SHORT && FRONT

VOWEL && E && SHORT && CENTRAL

VOWEL && I && LONG

VOWEL && I && SHORT

VOWEL && O && LONG

VOWEL && O && SHORT

VOWEL && U && LONG VOWEL && U && SHORT

Table 1 shows recognition results (expressed in word error rate, or WER) by the novel technique with the above polyphone assignments, together with those from a conventional triphone state tying technique (see, e.g., Young, supra), denoted as “Baseline” in the table.

TABLE 1
WER of JEIDA City Name Recognition

| | I | II | III | IV | Baseline |
|---|---|---|---|---|---|
| WER (in %) 1 m/s | 2.89 | 2.63 | 2.64 | 2.62 | 2.57 |
| WER (in %) 4 m/s | 1.96 | 1.74 | 1.66 | 1.77 | 1.85 |
| #mean | 7535 | 7565 | 7629 | 7643 | 7757 |
| #var | 237 | 237 | 237 | 237 | 237 |

From Table 1, it may be observed that:

Given one Gaussian PDF per state, performance differences among Systems II, III and IV and conventional triphone clustering are comparable. Word error rates (WERS) range from 2.576 by conventional triphone clustering to 2.64% by System III.

Performance was improved using the Gaussian mixture tying scheme described above. For example, WER was reduced to 1.85% with four mixture per state for the Baseline System. System III achieved the best performance, a WER of 1.66%.

The number of mean vectors of Systems I, II, III and IV was smaller than that for the Baseline System.

However, System I yielded the worst performance in both cases, with or without Gaussian mixture tying. It is clear that the polyphone assignment in System I is too general to have good performance.

System III achieved the best performance, with four mixtures per state. Performances by Systems II and IV were slightly better than the Baseline System.

The above results show that, because of the ability to tie triphone states across different phones within a triphone class, the requirement on accurate phone-set definition was able to be relaxed. Using the novel technique, different levels of polyphone clustering were assigned. The best performance was achieved with intermediate level of details where: (1) vowels were classified according to their type such as A or I and their lengths and (2) consonants were classified according to their syllabic characteristics.

Although the same performance and details of polyphone assignment may be achieved by conventional triphone clustering, substantial human involvement is required. Such flexibility provided by the novel technique allows ASR to be rapidly deployed for new applications in new languages. The footprint of Systems I, II, III and IV was smaller than the Baseline System.

Preliminary recognition results were then conducted using the well-known Minimum Description Length (MDL) principle (see, e.g., Shinoda, et al., supra). In the context of ASR, the MDL principle is used to control the number of states during triphone clustering. The MDL principle includes a parameter α for controlling the contribution due to description length. α=1.0 was selected for the experiment. Table 2, below, shows the recognition results.

TABLE 2
WER of JEIDA City Name Recognition Using MDL Criterion

| | I | II | III | IV | Baseline |
|---|---|---|---|---|---|
| WER (in %) 1 m/s | 2.91 | 2.85 | 2.85 | 2.85 | 2.54 |
| WER (in %) 4 m/s | 1.92 | 1.94 | 1.90 | 1.81 | 1.66 |
| #mean | 6743 | 6789 | 6847 | 6841 | 6947 |
| #var | 237 | 237 | 237 | 237 | 237 |

From Table 2, it may be observed that:

MDL reduced number of parameters dramatically. The number of mean vectors is reduced to around 6000, from around 7000 by the ML-based triphone clustering. However, performance was dropped as compared to that by the ML-based triphone clustering.

Baseline triphone clustering yielded the best performance.

The experiment did not encompass optimizing a for the novel technique. As a result, the number of mean of the Baseline System was larger than that of Systems I, II, III and IV. Those skilled in the pertinent art will understand that a may be optimized to advantage.

Although the present invention has been described in detail, those skilled in the art should understand that they can make various changes, substitutions and alterations herein without departing from the spirit and scope of the invention in its broadest form.

What is claimed is:

1. A system for developing acoustic models, comprising:
an acoustic model initializer configured to generate initial acoustic models by seeding with seed monophones;
a monophone retrainer associated with said acoustic model initializer and configured to retrain said monophones using a target database;
a triphone generator associated with said monophone retrainer and configured to generate seed triphones from said monophones using aligned training data;
a triphone retrainer associated with said triphone generator and configured to retrain said triphones using said target database; and
a triphone clusterer associated with said triphone retrainer and configured to cluster said triphones using a state-tying technique, said triphone retrainer configured to retrain said triphones again using said target database.

2. The system as recited in claim 1 wherein said acoustic model initializer is further configured to match each monophone in a target domain to a reference monophone in a reference domain using at least one articulatory characteristic.

3. The system as recited in claim 1 wherein said monophone retrainer is further configured to retrain said monophones using an entirety of said target database.

4. The system as recited in claim 1 wherein said triphone generator is further configured to align said training data using said monophones before said generating seed triphones.

5. The system as recited in claim 1 wherein said triphone retrainer is further configured to retrain said triphones using an entirety of said target database.

6. The system as recited in claim 1 wherein said state-tying technique is an implicit phone-set determination-based state-tying technique.

7. The system as recited in claim 1 wherein said state-tying technique ties states associated with said triphones based on Bhattacharyya distances and constraints.

8. A method of developing acoustic models, comprising:
generating initial acoustic models by seeding with seed monophones;
retraining said monophones using a target database;
generating seed triphones from said monophones using aligned training data;
retraining said triphones using said target database;
clustering said triphones using a state-tying technique; and
retraining said triphones using said target database.

9. The method as recited in claim 8 wherein said seeding with said seed monophones comprises matching each monophone in a target domain to a reference monophone in a reference domain using at least one articulatory characteristic.

10. The method as recited in claim 8 wherein said retraining said monophones using said target database comprises retraining said monophones using an entirety of said target database.

11. The method as recited in claim 8 wherein said aligned training data is aligned using said monophones before said generating seed triphones.

12. The method as recited in claim 8 wherein said retraining said triphones using said target database comprises retraining said triphones using an entirety of said target database.

13. The method as recited in claim 8 wherein said state-tying technique is an implicit phone-set determination-based state-tying technique.

14. The method as recited in claim 8 wherein said state-tying technique ties states associated with said triphones based on Bhattacharyya distances and constraints.

15. A digital signal processor, comprising:
data processing and storage circuitry controlled by a sequence of executable instructions configured to:
generate initial acoustic models by seeding with seed monophones;
retrain said monophones using a target database;
generate seed triphones from said monophones using aligned training data;
retrain said triphones using said target database;
cluster said triphones using a state-tying technique; and
retrain said triphones using said target database.

16. The digital signal processor as recited in claim 15 wherein said sequence of executable instructions is further configured to match each monophone in a target domain to a reference monophone in a reference domain using at least one articulatory characteristic.

17. The digital signal processor as recited in claim 15 wherein said sequence of executable instructions is further configured to retrain said monophones using an entirety of said target database.

18. The digital signal processor as recited in claim 15 wherein said sequence of executable instructions is further configured to align said training data using said monophones before generating seed triphones.

19. The digital signal processor as recited in claim 15 wherein said sequence of executable instructions is further configured to retrain said triphones using an entirety of said target database.

20. The digital signal processor as recited in claim 15 wherein said state-tying technique is an implicit phone-set determination-based state-tying technique.

21. The digital signal processor as recited in claim 15 wherein said sequence of executable instructions is further configured to tie states associated with said triphones based on Bhattacharyya distances and constraints.
